(19) United States
(12) Patent Application Publication
(10) Pub. No.: US 2003/0028385 A1
(43) Pub. Date: Feb. 6, 2003

(54) Audio reproduction and personal audio profile gathering apparatus and method

(76) Inventor: Athena Christodoulou, Bristol (GB)

Correspondence Address: LOWE HAUPTMAN GILMAN & BERNER, LLP, Suite 310, 1700 Diagonal Road, Alexandria, VA, 22314, US

(21) Appl. No.: 10/185,726

(22) Filed: Jul. 1, 2002

(30) Foreign Application Priority Data
Jun. 30, 2001 (GB) 0116071.2

(51) Int. Cl. G10L 11/00

(52) U.S. Cl. 704/278

(57) ABSTRACT

An audio player includes a memory storing one or more audio data files and at least one personalized audio profile comprising for each ear a map of amplitude audio frequency profile. A file selector permits a user to select one or more of the stored audio data files and at least one of the personalized profiles. A data processor accesses the selected files and profiles from the memory and processes the selected files with the profile to generate a processed audio signal for each ear. An actuator reproduces the audio information stored in the processed audio signal as sound for each ear. Personalized profiles are produced by monitoring and storing the responses of users to audible signals having different frequencies.

### FIELD OF INVENTION

This invention relates to improvements in audio reproduction.

### DISCUSSION OF PRIOR ART

The popularity of music with people of all ages is showing no signs of decreasing. In addition to the bulky home entertainment systems that are present in almost every household, recent developments in data storage have seen considerable advances in portable audio reproduction devices.

The Sony Walkman (Registered Trademark), which allowed sounds recorded as analog signals on audio cassette to be reproduced, is perhaps the earliest example of a successful portable audio device. Prior to the Walkman, the only way of hearing recorded music on the move was the portable radio or a bulky cassette player. In recent years, the compact disk has replaced the audio cassette due to the improved quality of the audio reproduction that can be achieved.

Compact disks can hold a large amount of data, but devices which use these disks are relatively bulky. An improvement would be to store the data in a non-volatile memory, but until recently, the cost of the memory has made such a device unrealistic. A drop in the costs of electronic memory, and the development of standards for electronic data compression techniques, permitting many minutes of high quality audio to be stored in a relatively small area of electronic memory, has made these devices a commercial reality.

Because of their compact size, and the resulting limited capacities of the batteries that are used, most of these devices use headphones as the means for producing an audio signal from the stored data. Playing the sound directly to each ear reduces the amount of power required. However, for many people, particularly those with impaired hearing, the sound quality achieved using earphones is unsatisfactory.

It is known to provide portable music devices with simple volume controls to allow the level of sound produced to be varied by the user. However, this offers only limited control over the sound reproduction to each ear of a user.

Devices with basic graphical equalization are also known. These have, to date, typically comprised a series of slide switches which can be moved by a user to provide a crude variation in amplitude of a band of frequencies within the range of the audio device. If the switches are accidentally moved, the settings are lost. For this reason, graphic equalizers are unpopular on portable devices.

In another example, a factory set bass boost facility is commonly provided which increases the relative amplitude of low frequencies over higher frequencies. This can either be enabled or disabled by a user operated switch and is pre-programmed into the device. Not everyone likes the effect that this facility provides.

### SUMMARY OF INVENTION

In accordance with a first aspect, the invention provides an audio device comprising:

a memory arrangement for storing one or more audio data files and an amplitude frequency personalized profile for at least one ear of at least one user;

a file selector for enabling selection of one or more of the stored audio data files and at least one of the personalized profiles;

a data processor for accessing the one or more selected files and profiles from the memory and processing the selected files with the profile to generate for the at least one ear a processed audio signal.

In cases of particular interest, the device is a portable audio player including an electro-acoustic transducer for each ear of a user, for example, a pair of headphones.

Such a portable audio device can provide improved audio reproduction by applying a personalized profile to the stored data to personalize the sound quality of the final audio.

By portable, we simply mean that the device is small enough to be held in the hand, although ideally the device may be pocket sized so that it can readily be carried in the pocket of a jacket or shirt. It is also typically battery operated.

The device can combine the personalized profile with the stored audio data in the digital domain prior to the processor converting the combined digital data into an analog signal for reproduction. Thus, the processor applies the profile to the raw data each time the data are reproduced. The audiogram can be multiplied with the audio signal on a frequency by frequency basis.

In a further refinement, the processor may apply the profile to a stored data file to produce a processed data file, the processor stores the processed data file in the memory, and the processor accesses the processed data file when the audio data is to be reproduced.

The apparatus may include input means for inputting additional data files to the memory. The processor may apply the selected profile to the input data to produce the processed data file which is stored in memory.

Where the memory contains more than one profile, the apparatus may include a selector to enable the user to select the appropriate profile to be applied to a data file when the data are being copied to the memory, or when the data file is being accessed for reproduction by the processor.

The personalized profile may comprise an audiogram comprising a map of decibel gain against frequency (dB/Hz), which can be embodied as a digital filter having a personalized frequency response. The frequency response of the filter may be user definable prior to storage in the memory. The audiogram may be continuous or discontinuous, i.e., gain at each frequency or a at a set of spaced apart frequencies across the range. Where it is discontinuous, the gains may be interpolated to provide the required gain of any chosen frequency in the range.

The profile may comprise a pair of audiograms, one audiogram being applied to each of the two channels of a stereo signal. This is especially beneficial to users of headphones who may have impaired hearing in only one ear. Each audiogram may define the profile of a digital filter.

It is envisaged that a portable device including the invention will be especially useful for people with hearing difficulties as it permits the audio reproduction to be tailored to match the frequency response of each user's hearing. For example, if a user has limited hearing over a small range of frequencies within the normal range of audible frequencies, the profile may increase the amplitude of these frequencies relative to the other frequencies in the audible range. This applies particularly if the frequency response in one ear is markedly different from that in the other ear. In that case, the user response to sound provided through a conventional headphone arrangement may be very different from that obtained in a normal environment.

The memory may comprise at least one area of non-volatile memory. The memory may be integral to the device or may be removable from the device. Where the memory is removable, it is most preferred that a separate area of memory which is non-removable is provided to in which the personalised profile is stored. The device may contain 32 Mbytes of memory, or perhaps 64 Mbytes or more. To minimise the amount of memory needed the audio files may comprise compressed data files, possibly compressed using the MP3 data compression format or the “.wav” format. Of course, other compression formats may be employed and it is envisaged that the device may be compatible with any one of a number of such formats.

Where the data is compressed, the processor may be adapted to decompress the data in the data file prior to applying the personalised profile to the decompressed data.

It is envisaged that the device will mostly be used to store data files representing musical songs. For example, each file stored in the memory of the device may comprise a track from an album. The data files may be purchased as digital data, such as the data stored on a compact disk. Alternatively, they may be obtained over the internet.

Also, while the invention is principally of benefit to portable devices in which headphones are used, it can be applied to non-portable devices as well.

In accordance with a second aspect of the invention, an apparatus for generating a personalized user profile comprises an audio signal generator generates audio signals across a range of audible frequencies in accordance with a range of different types of audio data. A selector enables a user to select a type of audio data. An input device monitors the response of a user to the generated signals. A profile generator generates a personalized profile for a selected type of audio data from the response of the user. The profile comprises a personalized audiogram. A memory stores the generated personalized profile.

The apparatus thus generates at least one test audio signal and produces a profile in response to user inputs that are dependent upon the test audio signals. It preferably generates a plurality of test signals.

Many different audio signals may be produced by the apparatus to generate the profile. A specific example of a suitable signal is a pair of tones which are played simultaneously or one after the other. They may have identical amplitudes. In this case, the user may be prompted to identify which, if any, of the tones sounded the loudest. The profile may then preferentially amplify the tone that sounded the quietest more than the other tone.

In an alternative, the test audio signals may comprise musical samples such as parts of songs. The test audio samples may contain a wide range of frequencies across the audible range, or one or more frequencies across a sub-range of audible frequencies.

In one arrangement where the memory contains a set of different audio samples, the apparatus includes prompting means for prompting the user to indicate which audio sample they preferred to listen to, and in which the profile generating means generates a personalised profile from the users response to the prompt.

The test audio samples stored on the apparatus may include a range of different types of audio data, such as a piece of speech, a jazz track or a dance track, and generate a test set for each type of audio data. A personalised profile may be generated for each type of audio data.

The test provided by the device may be interactive. For instance, one or more audio samples may be played and the user asked a question or questions about the sample(s). A new sample may be played which is altered using a profile generated from the users responses and farther questions asked until the user indicates that they are happy with the sound.

In this manner, the apparatus may generate a personalized profile that comprises at least one audiogram having a frequency response dependent upon the sensitivity of the users ear to different frequencies. The audiogram may compensate for deficiencies in the users hearing. Of course, it may alternatively simply allow a user to create a frequency response which they find pleasing regardless of the frequency response of their ears.

A separate profile may be produced for each of the left and the right channels of a stereo system. To obtain maximum benefit, the user should wear a set of headphones to allow each ear to be isolated during testing.

A separate profile may be produced for each of a set of different types of music. For example, a profile may be provided for classical music and a profile for pop music.

The apparatus may include a display that is adapted to display a graphical illustration of the personalised profile. Conveniently, this may comprise a bar graph or line graph type display of frequency against amplitude.

The input device may permit the user to directly manipulate the personalised profile independent of any test audio signals. This allows complete personalisation of a stored profile.

The apparatus may include means for copying the generated profiles to portable device, the portable device storing the profiles in memory.

The apparatus may further include means for editing a personalised profile by a user. This allows the profile to be tailored to a users preferences independent of the tests or after a basic profile has been produced by the tests. This may be achieved, for example, by way of a graphical interface which displays the profile as a set of sliders on a display which can be moved up or down by the user. Each slider corresponds to a different frequency or range of frequencies and mimics an analogue graphical equaliser.

In a most preferred arrangement the apparatus comprises a personal computer (PC). The computer may include a computer program stored in memory which when running on the computer causes the computer to generate the audio signals, issue appropriate prompts to the user and receive the users inputs responsive to the audio signals.

It will be appreciated, however, that the apparatus of the second aspect of the invention and the portable device of the first aspect may be combined into a single unit. This would permit audio files to be stored and replayed on the move as well as allowing a user to generate one or more personalised audio profiles.

In a further refinement, the personalised profile may include an indicator of a preferred voice type selected from one or more user selectable voice types, the device processing audio data such that any speech contained in the audio data is reproduced using the preferred voice type.

The device may select the preferred voice type from a predetermined selection of voice types based upon the shape of an audiogram which forms part of the profile. For example, the device may select the voice type which will be easiest for a user to hear as indicated by the audiogram of their personalised profile.

In a further alternative, the user may be played samples of different voices and asked to select which voice they preferred to listen to/found easiest to hear.

In a simple arrangement, the voice preference indicator may be stored in a data file together with one or more audiograms. This allows the device to reproduce audio data, such as news broadcasts, in a way which is easy for a heavily ‘impaired’ person to hear.

According to a third aspect the invention provides a data carrier which includes a computer program which when running on a processor makes the processor operate in accordance with the second aspect of the invention.

In accordance with a fourth aspect the invention provides a method of playing stored audio data comprising the steps of:

accessing a personalized user profile for an audio signal, wherein the personalized user profile comprises for each ear a map of amplitude-frequency profile over a range of audible frequencies;

selecting at least one audio data file;

processing the selected audio data file with the personalized user profile to produce a processed audio signal; and

feeding the processed audio signal to a sound generator which separately for each ear audibly reproduces the information stored in the processed audio signal.

The method may comprise storing the processed audio signal in a memory and selecting the processed audio signal from the memory for reproduction. The method may further include the steps of generating a plurality of user profiles and selecting one of the profiles corresponding to the content of a selected audio data file.

For example, a profile may be stored for jazz music, a profile may be stored for classical music, etc. If a jazz song is selected, then the jazz profile may be automatically selected from the memory.

The method may be used to produce a profile which can be stored in a device according to the first aspect of the invention.

### DESCRIPTION OF THE DRAWINGS

There will now be described by way of example only, one embodiment of the present invention with reference to the accompanying drawings of which:

FIG. 1 is a perspective view of an audio device in accordance with a first aspect of the present invention;

FIG. 2 is a schematic overview of an apparatus in accordance with the present invention;

FIG. 3 is a flow chart of the steps that are carried out in the generation of a personalised audio profile;

FIG. 4 is a flow chart of a an alternative set of steps that are performed in generating a personalised audio profile; and

FIG. 5 illustrates a sample personalised profile used by the device of the invention during audio reproduction.

### DESCRIPTION OF PREFERRED EMBODIMENTS

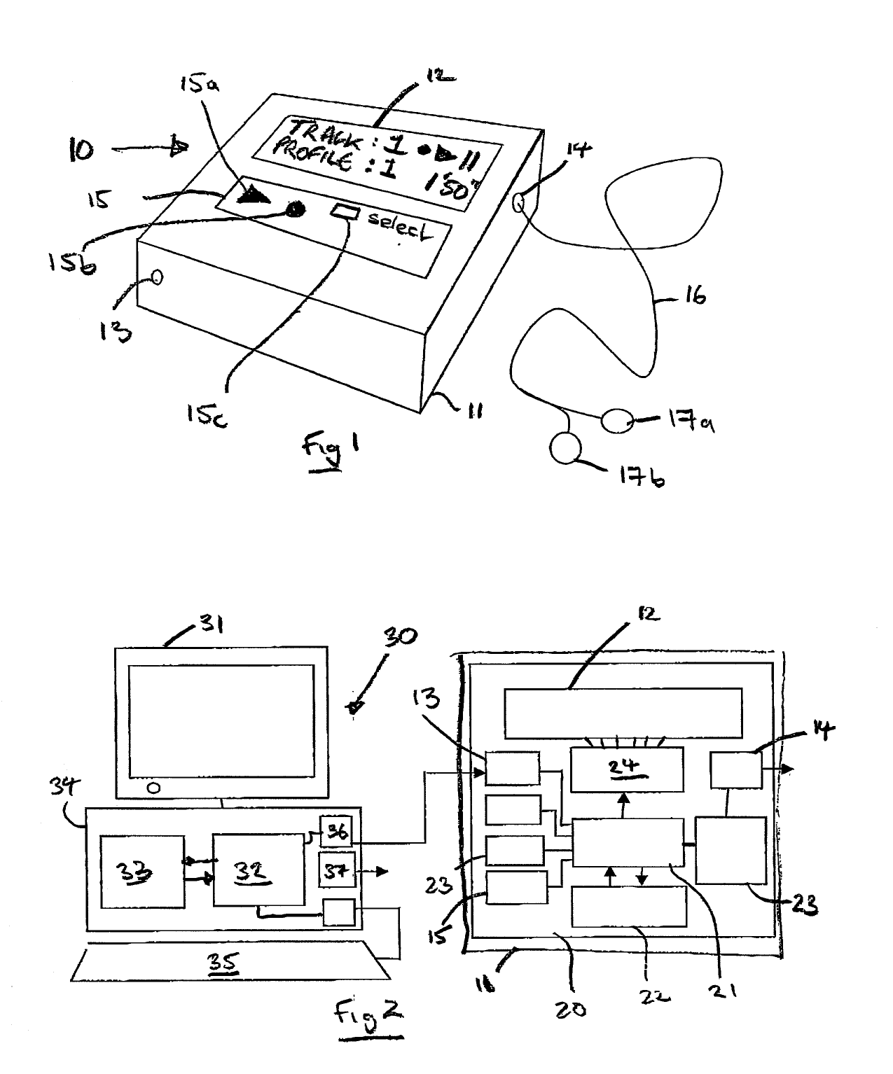

An audio device 10, as illustrated in FIG. 1 of the accompanying drawings, comprises a rectangular body 11 which includes a liquid crystal display panel 12, an input socket 13, and output socket 14 and a plurality of user operated selection buttons 15 provided in a group on the front face of the housing. The input socket 13 shown is of the universal serial bus (USB) type and is adapted to receive an appropriate connector (not shown) on a cable for passing audio information to the device. The output socket 14 comprises a jack socket for receiving a stereo plug which is provided on a lead 16 extending from a pair of stereo headphones 17a, 17b. The buttons 15 permit a user to select a piece of audio data—such as a musical track—from a range of samples stored in the device 10. The input buttons 15 include a play button 15a to start the device playing the selected sample, a stop button 15b to stop the device playing, and a sample selection button 15c that allows the user to select from the samples held in the device. The display 12 allows the user to see which sample has been selected and may also displays information about the sample such as the artist, the title, the sample run time etc.

Of course, other buttons (not shown) may be provided such as a volume control, skip track/previous sample etc as is well known.

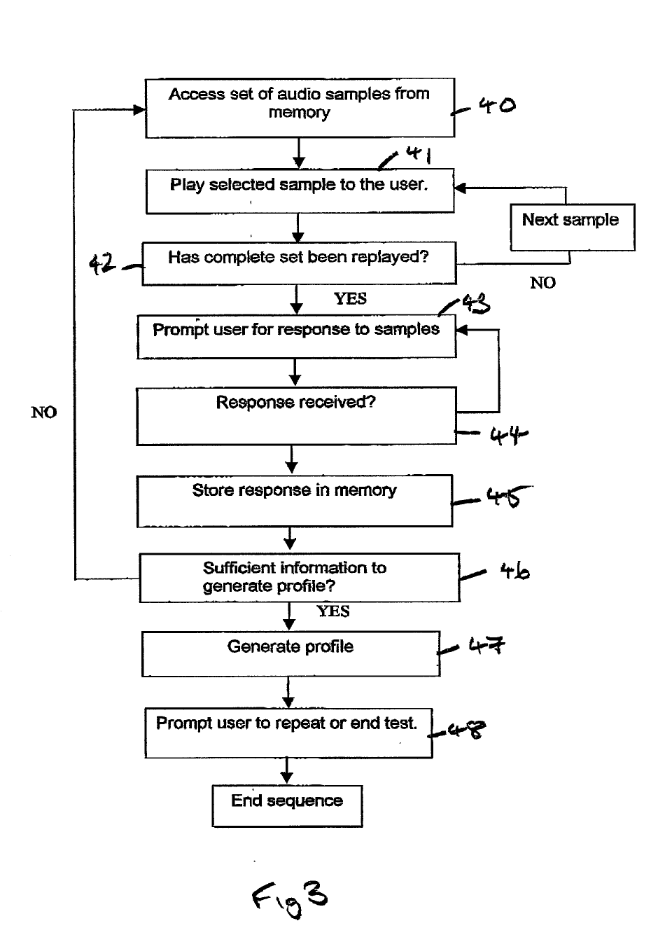

Referring now to FIG. 2 of the accompanying drawings, the housing 11 of the device 10 contains a printed circuit board 20 which interconnects each of the input buttons 15, the display 12, the input USB port 13 and the output socket 14 to an electronic circuit. The circuit includes a processor 21 and an area of electronic memory 22 which contains programme instructions that run on the processor when the device is operating and also permit data supplied to the input port 13 to be stored in the memory 22 on the device 10. The data is stored as data files within the memory 22. Each data file contains the audio information required to reproduce an audio sample and may also include additional information about the sample such as its length, title and so on. The data in the files is compressed to minimise the amount of memory required. A battery 23 within the housing drives the electronic circuit.

The processor 21 receives input signals from the input buttons 15 and the input socket 13. In turn, the processor 21 generates an output signal which is fed to a digital to analogue converter 23 that drives the headphone socket. In practice, two D/A converters are used to generate each of the two analogue channels of a stereo signal. The processor 21 also produces output signals which are passed to a display driver 24 that drives the display 12.

In use, the processor 21 accesses one of the data files stored in the memory 22 in response to a user input. The accessed file is decompressed by the processor 21 to produce a digital data stream which is fed to the input of the digital to analogue converter 23. The output of the analogue to digital converter 23 is an analogue audio signal that is fed to the headphones 17a, 17b. The user can then listen to the reproduced audio sample that he or she has selected.

As well as containing a set of data files the memory 22 also includes one or more personalised audio profiles. One of the input buttons 15 provided on the housing permits the user to select a profile from the stored profiles. The processor 21 applies the profile to the uncompressed digital data prior to converting the data to an analogue signal. This allows the type of sound reproduction to be controlled by the user. The display panel 12 permits the user to identify which profile is currently selected, and the display changes as different profiles are selected. In the example shown in FIG. 1, the user has selected the first stored sample (track “1”) and the first profile (profile “1”).

Each audio profile comprises a pair of audiograms. Each audiogram defines the frequency response of a filter that is applied to the left or right channel of the audio fed to the D/A converter and allows the user to tailor the sound of the audio device. An example of a personalised profile is illustrated in FIG. 5 of the accompanying drawings. It is notable that the profile for each ear is different.

The processor of the portable device decompresses a stored audio data file to produce a stream of digital data. This data stream is then combined with the chosen profile to produce a processed stream. The processed stream is then fed to the D/A converter. The profile allows complex shaping of the audio data stream to meet the demands or needs of the users listening preferences.

FIG. 2 shows the portable device connected by a cable 25 connected to the input socket 13 to a personal computer 30. The computer 30 supplies new audio samples to the portable device 10 for storage in the memory 22, and also supplies new/modified personalised profiles to the portable device 10. Thus, in this embodiment the personalised profiles are generated remotely from the portable device 10 by the computer 30 to minimise the processing requirements of the portable device 10.

The computer 30 comprises a monitor display 31, a processor 32 and an area of memory 33 located within a common housing 34, an input device 35 such as a mouse or keyboard, and an output port 36 such as a USB port. The output port allows the computer to output data across the cable 25 to the portable device 10. It also includes an audio output socket 37. This allows a pair of headphones—preferably the headphones 17a, 17b used with the portable device 10, to be connected to the computer 30.

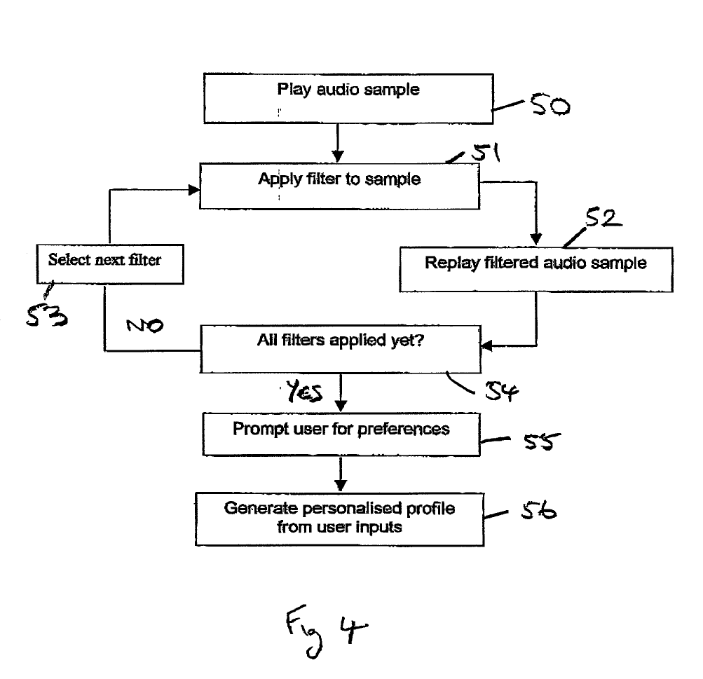

The memory 33 includes a computer program which can be run by the processor of the computer 30 to perform a sequence of events required to generate one or more personalised user profiles and to output the profile(s) through the output port to the portable device 10. The computer performs the sequence of events illustrated in FIG. 3 to produce a personalised profile.

In a first step, the processor accesses 40 a set of test audio samples held in the memory. Each of the audio samples is played 41 in sequence to the user until all of the set has been played 42. The computer display then prompts 43 the user for a response to the played samples. The programme waits 44 for a response which is stored 45 in the memory. The testing is continued by playing further samples or issuing additional prompts until the processor has sufficient information 46 to generate 47 an audiogram (dB/Hz) profile of the frequency response of the users ears. To petit each ear to be tested independently, each test sample may be played first to one ear and then the other of the user. This allows two audiograms to be produced—one for each ear with the pair of audiograms defining the personalised profile of the user.

Existing appropriate apparatus for obtaining audiograms can be modified for this purpose or incorporated into an appropriately controlled system—conventional means for obtaining audiograms are available. An exemplary system for obtaining conventional audiograms on a PC with isolation headphones is the Ear Q Technologies Reference Hearing Analyzer System, described in Pro Audio Review, December 2001.

Once the personalised profile has been produced it is stored in the computer memory and the user is prompted 48 to repeat the test or to end the testing. The computer then presents the user with the option of modifying the stored profile.

After a personalised profile has been generated it is output to the portable device where it is stored in the memory of the device. The device automatically allocates the profile a title, e.g. profile “1” which is displayed on the display when the profile is selected by the user.

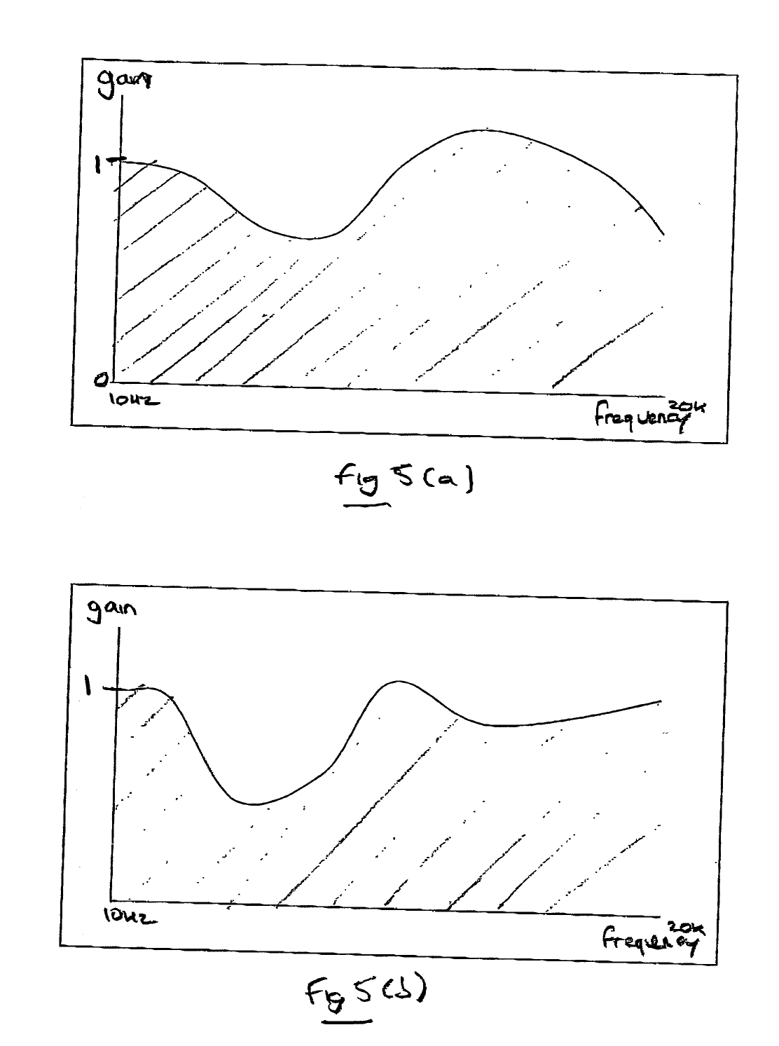

A modified sequence of events can be provided for the generation of personalised profiles. The computer may utilise only one of the two sequences or may offer a user a choice of sequence to apply. The modified sequence is illustrated in FIG. 4 of the accompanying drawings.

In the modified sequence, the user is initially played 50 a sample of audio data. This may be a user selected sample such as a favourite piece of music or may be selected from a set of default samples stored in the memory of the computer. A filter is then applied 51 to the sample and the same sample of audio data is then replayed 52 several times. Each time, a different frequency-amplitude response profile or filter is applied 53 to the sample. After all the samples have been replayed 53, the user is asked 55 one or more questions about his or her preferences from the reproduced samples. The processor generates 56 a personalised profile from the answers to these questions.

Each filter comprises is defined by an audiogram which has a unique frequency-amplitude response over the range of audible frequencies or perhaps a sub range of these frequencies.

This alternative is especially useful for the reproduction of music over headphones as it allows the user to tailor the sound to their particular preferences. The users preference may have no correlation to the actual frequency response of their ears.

Whilst the invention has been described above with the portable device storing the personalised profiles, several alternatives are envisaged.

In one option, the portable device may itself generate the personalised profiles rather than a separate remote device. For example, the processor may run a computer programme stored in the memory of the device when a personalised profile is to be generated. This produces a more flexible portable device although it does increase the processing overheads required.

In another modification, the personalised profile may be applied to the stored data in the device to generate a set of stored modified data files which comprise processed audio data. Whenever the user selects an audio file the device replays the modified data file which already includes the effect of the personalised profile.

In a still further alternative, whenever new audio data is supplied to the input socket the processor applies the personalised profile to the incoming data and generates a modified data file which is stored in the memory. The original unmodified data does not need to be stored at all.

Finally, in a further alternatives the computer may apply the profile to the data in the data files prior to transmitting only processed audio data to the portable device. This requires no modification of any existing portable device to gain the benefits of the personalisation of the present invention. The disadvantage is that the stored files in the portable device are personalised to one user and so limits the usability of the device for multiple users who may require their own personalised profiles.

The invention is particularly applicable to arrangements and devices where it is preferred for the listener to use headphones. Examples may be a personal audio reproduction device (such as a CD player or an MP3 player) and also a personal computer or an electronic book reader. A user may have different profiles, for example, for listening to speech (such as an audiobook or a speech-containing electronic book) and music, or different musical styles.

1. An audio device comprising:
a memory arrangement for storing one or more audio data files and an amplitude frequency personalized profile for at least one ear of at least one user;
a file selector for enabling selection of one or more of the stored audio data files and at least one of the personalized profiles;
a data processor for accessing the one or more selected files and profiles from the memory and processing the selected files with the profile to generate for the at least one ear a processed audio signal.

2. An audio device according to claim 1 further comprising an actuator for reproducing as sound the audio information stored in the processed audio signal for the at least one ear.

3. An audio device according to claim 1 wherein the stored audio data files and the profile for at least one ear are digital signals and the data processor is arranged for combining the digital signals indicative of the personalized profile and the stored audio data file to derive a combined digital signal in the digital domain and for converting combined signals into an analog signal for reproduction.

4. An audio device according to claim 2 wherein the processor is arranged for applying the profile to a stored data file to produce a processed data file, the processor being arranged to (a) store the processed data file in the memory, and (b) access the processed data file when the audio data is reproduced.

5. An audio device as claimed in claim 2, wherein the device is an audio player device that is in a housing which can be carried by a user.

6. An audio device according to claim 5 further including an arrangement for inputting new audio data files to the device, the processor being arranged for automatically applying the selected profile to new data files which are to be stored in memory.

7. An audio device according to claim 6 wherein the processor is arranged for applying only data files that have been processed to the memory.

8. An audio device according to claim 1 wherein the selector is arranged for enabling a user to select the appropriate profile to be applied to a data file while the data are being copied to the memory, or while the data file is being accessed for reproduction by the processor.

9. An audio device according to claim 1 wherein the personalized profile comprises an audiogram (db/Hz) over a range of audible frequencies.

10. An audio device according to claim 9 wherein the audiogram includes a digital filter.

11. An audio device according to claim 9 wherein the profile comprises a pair of audiograms, one audiogram being applied to each of a pair of channels of a stereo signal.

12. An audio device according to claim 1 wherein the stored data files comprise compressed data, and in which the processor is arranged to decompress the data in the data file prior to applying the selected personalized profile to the decompressed data.

13. Apparatus for generating a personalized user profile, the apparatus comprising:
an audio signal generator for generating audio signals across a range of audible frequencies in accordance with a range of different types of audio data;
a selector for enabling a user to select a type of audio data;
an input device for monitoring the response of a user to the generated signals;
a profile generator for generating a personalized profile for a selected type of audio data from the response of the user, the profile comprising a personalized audiogram; and
a memory for storing the generated personalized profile.

14. The apparatus of claim 13 further including circuitry for supplying the generated personalized profile(s) to a portable audio reproduction device, the portable device including a memory for storing the profiles.

15. A method of playing stored audio data comprising the steps of:
accessing a personalized user profile for an audio signal, wherein the personalized user profile comprises for each ear a map of amplitude-frequency profile over a range of audible frequencies;
selecting at least one audio data file;
processing the selected audio data file with the personalized user profile to produce a processed audio signal; and
feeding the processed audio signal to a sound generator which separately for each ear audibly reproduces the information stored in the processed audio signal.

16. The method of claim 15 further comprising storing the processed audio signal in a memory and selecting the processed audio signal from the memory for reproduction.

17. The method of claim 16 further including the steps of generating a plurality of user profiles and selecting one of the profiles corresponding to the content of a selected audio data file.

18. The method of claim 15 further including the steps of generating a plurality of user profiles and selecting one of the profiles corresponding to the content of a selected audio data file.
